(19) United States
(12) Patent Application Publication
(10) Pub. No.: US 2010/0090654 A1
(43) Pub. Date: Apr. 15, 2010

(54) SECONDARY CELLS WITH DISTINGUISHING PHYSICAL FEATURES

(76) Inventors: Daniel Breiting, Zerufa (IL); Amnon Saar, Tel-Aviv (IL); Dror Manor, Hertzlia (IL)

Correspondence Address: DANIEL J SWIRSKY, 55 REUVEN ST., BEIT SHEMESH, 99544, IL

(21) Appl. No.: 12/520,544

(22) PCT Filed: Dec. 20, 2007
(86) PCT No.: PCT/IL07/01581

§ 371 Date: Jun. 22, 2009

Related U.S. Application Data
(60) Provisional application No. 60/875,858, filed on Dec. 20, 2006.

(51) Int. Cl. H02J 7/00; H01M 2/10

(52) U.S. Cl. 320/137; 429/100

(57) ABSTRACT

An overall standard sized battery having a physical characteristic for differentiation between rechargeable and non-rechargeable types, and a corresponding feature in the battery cavity of an electronic device, such that the electronic device can discern this physical characteristic. A mechanical modification may be made to the standard size rechargeable batteries. This is detected by the electronic product, and enables the product to easily distinguish between standard primary batteries and rechargeable batteries having the same overall standard size dimensions. The product is configured to safely recharge only secondary batteries. Possible mechanical modifications to the battery include: the size and/or shape of the positive tip or the negative end of the battery; the cross-sectional shape of the barrel of the battery; an added notch or projection on the battery; and extension or shortening the length of the battery. Detection methods may be mechanical, optical, electrical or magnetic.

### FIELD OF THE INVENTION

The present invention relates to the field of batteries, especially batteries with distinctive features for distinguishing between primary and secondary batteries.

### BACKGROUND OF THE INVENTION

Standard size batteries according to the various ANSI C18 standards, are available with different battery chemistries. Some are secondary (rechargeable) batteries such as Nickel-Cadmium (Ni—Cd) or Nickel Metal Hydride (NiMH). Others are primary (non-rechargeable) batteries, such as Alkaline and Lithium Iron Disulphide (LiFeS₂). It is potentially dangerous to attempt to charge such primary cells, as they may heat up excessively or even explode when an excessive current is forced through them.

Portable electronic products can use both type of batteries. In order to recharge the secondary batteries, the user sometimes needs to take them out of the product and put them in a separate charger. This limitation leads to inconvenience in usage of electronic devices. Many mobile devices today have a connection to an external wall charger, or have their own built-in charger for connection to a wall source, such that the internal battery can be charged in situ. Such devices sometimes include battery chemistry detection circuits, such as those described in co-pending International Patent Application No. PCT/IL2007/001532 for “Charging Methods for Battery Powered Devices”, herewith incorporate by reference in its entirety. Use of such circuits enables the device to determine whether the installed battery is a secondary battery and can be safely charged, or whether it is a primary battery which would be unsafe to charge. However, such circuits are not common on low cost, popular electronic devices, because of the expense of providing the circuitry, which, to be fully effective, generally needs to be microprocessor controlled.

It would therefore be useful to provide a method and system whereby the nature of the battery chemistry would be simply indicated by the battery itself, without the need for complex electronic circuitry in the device, yet without diverging from the standard ANSI overall sizes of such batteries.

Although the term battery, according to strict technical nomenclature, comprises a number of cells, throughout this application, the term is to be understood to be interpreted and is thuswise claimed according to its popular usage, whereby a single cell is also called “a battery”.

### SUMMARY OF THE INVENTION

The present invention seeks to provide new forms of batteries, having the overall standard sizes of batteries in common use, but having an additional physical characteristic for differentiation between rechargeable and non-rechargeable types. A corresponding feature is provided in the electronic device such that the electronic device can discern this physical characteristic, and enable or disable its battery charging ability accordingly.

According to a first preferred embodiment, a small mechanical modification is made to the standard size rechargeable batteries. This is detected by the electronic product when the battery is inserted into its cavity, and enables the product to easily distinguish between standard size primary batteries and rechargeable batteries having the same overall standard size dimensions. The product can then be configured to safely recharge only batteries which are detected as secondary.

According to different preferred variations of this invention, the physical modifications can be mechanical modifications, and various detection methods of these mechanical modifications can be provided, whether mechanical, optical, magnetic or electrical. It is to be understood that the term mechanical modification is meant to include any physical modification to the battery which manifests itself externally as a modified mechanical part of the battery, even if detection of that mechanical modification is not performed mechanically. Thus, an electrically conductive or optically reflective region of the batteries' outer surface is also termed a mechanical modification in this application, even though detection of that modification may preferably be performed electrically or optically.

Possible preferred mechanical modifications may include, though are not limited to:
(i) Change in the size and/or shape of the positive tip of the battery
(ii) Providing the barrel of the battery with a different shape such as a triangular or rectangular prismatic shape.
(iii) Addition of a notch or a projection somewhere on the battery body.
(iv) Extension or shortening of the length of the battery by a small amount
(iv) Change in the size and/or shape of the negative end of the battery.
(v) Change in the electrical or optical surface properties of the battery outer cover.

Possible detection methods may include, though are not limited to:
(i) Mechanically operated Micro-switch
(ii) Optoelectronic-switch
(iii) Magnetic proximity switch
(iv) Electrical continuity or voltage test

It is important that the device in which the detection apparatus for the modified batteries of the present invention is fitted will continue to operate with standard batteries, unmodified according to the present invention. This is essential to provide for general acceptance of the batteries of the present invention. The details of the various embodiments of the present invention device must be such that the device will work normally with an unmodified battery, while the modified battery according to the present invention will activate the charge enabling or disabling facility of the device, thus fulfilling its intended function but without detracting from its normal historic mode of operation. Conversely, the modified battery itself must be such that it will operate normally in a device which is not fitted with the detection apparatus of the present invention. Both aspects of the invention, modified battery and detection equipped device must therefore be completely transparent for normal operation, to the special characteristics of the present invention.

The present invention thus enables a simple, low cost method of distinguishing between primary and secondary standard sized batteries. It enables accurate and safe electro-mechanical, electro-optical, magnetic or optical detection of batteries that are can be safely recharged, without the need for complex electronic detection circuits. This ability to safely detect a rechargeable battery can improve the convenience of new electronic products by enabling the user to recharge his batteries while they are in the product, and still keep the benefit of also using primary batteries in the product when needed. Although the present invention has been described in this application as applicable for use in electronic devices, it is to be understood that it is equally useful for application in battery chargers as stand-alone instruments.

There is thus provided in accordance with a preferred embodiment of the present invention, a system for providing battery power to an electronic device having a battery cavity, the system comprising:
(i) a battery having at least one physical characteristic other than its chemistry for differentiation between rechargeable and non-rechargeable types, and
(ii) a corresponding feature of the battery cavity adapted to differentiate between the battery types by means of the physical characteristic.

In the above described system, the physical characteristic may preferably be the external shape of the battery. In this case, the external shape may preferentially be an essentially rectangular barrel, and the corresponding feature of the battery cavity may be either a micro-switch or an opto-electric circuit activated by the essentially rectangular barrel. Alternatively and preferably, the battery may have a generally cylindrical body, and the external shape may be a projection from the generally cylindrical barrel, and the corresponding feature of the battery cavity may then be a micro-switch or an opto-electrical circuit activated by the projection. In all of these systems, the electronic device preferably comprises charging circuits which are applied to the battery only when the corresponding feature discerns that the physical characteristics are those associated with a rechargeable battery.

In accordance with still another preferred embodiment of the present invention, the physical characteristic may preferably be the size of the positive contact of the battery. In such a case, the corresponding feature of the battery cavity may preferably be a two-part contact adapted to provide an enabling signal to provide recharging current only to a battery having a positive contact of at least a predetermined diameter. Alternatively and preferably, the corresponding feature of the battery cavity may be a two-part contact adapted to provide an enabling signal to provide recharging current only to a battery having a positive contact of less than a predetermined diameter.

There is further provided in accordance with still another preferred embodiment of the present invention, a system as described above, and wherein the physical characteristic is either one of the size or shape of the negative contact of the battery. The corresponding feature of the battery cavity is then preferably a two-part contact adapted to provide an enabling signal to provide recharging current only to a battery having a negative contact of less than a predetermined diameter.

There is even further provided in accordance with another preferred embodiment of the present invention, a system as described above, and wherein the physical characteristic is a partial coverage of the negative base of the battery by an insulating layer. The corresponding feature of the battery cavity is then preferably a negative contact adapted to provide an enabling signal to provide recharging current only to a battery having the partial coverage of the negative base of the battery by an insulating layer.

Furthermore, in accordance with yet another preferred embodiment of the present invention, in the above described system, the physical characteristic may preferably be the length of the battery. In this case, the length may preferably be different from that of a standard battery, and the corresponding feature in the electronic device is either a micro-switch or an opto-electric circuit activated by a battery of the different length.

There is also provided in accordance with a further preferred embodiment of the present invention, a system wherein the physical characteristic is the presence of a magnetized material mounted in or on the battery. The corresponding feature of the battery cavity is then preferably a magnetic field detection element adapted to provide an enabling signal to provide recharging current only to a battery having the magnetized material associated with it.

In accordance with yet another preferred embodiment of the present invention,

the physical characteristic may be a region of electrical conductivity on the generally insulating outer surface of the battery, and the corresponding feature of the battery cavity may then be a pair of electrical contacts which are connected and thus provide an enabling signal to provide recharging current only by a battery having the region of electrical conductivity on its generally insulating outer surface.

In any of the above described systems using an opto-electric detection circuit, the circuit preferably may comprise an emitter and a photodetector, and the circuit is closed when a battery having a predetermined reflective part of its surface is inserted into the cavity, such that light from the emitter is reflected into the photodetector. Alternatively and preferably, the opto-electric circuit may be closed when a battery having a predetermined modified shape is inserted into the cavity, such that light from the emitter may be transmitted into the photodetector.

There is further provided in accordance with yet another preferred embodiment of the present invention, a method of preventing the charging of a primary battery, comprising:
(i) providing a battery having at least one physical characteristic other than its chemistry for differentiation between primary and secondary batteries,
(ii) providing a battery charger having a charging circuit and a battery cavity for receiving a battery to be charged, and
(iii) equipping the battery cavity with a feature adapted to differentiate between primary and secondary batteries by means of the physical characteristic.

In the above described method, the physical characteristic may preferably be the external shape of the battery, and the battery cavity may preferably detect the physical characteristic of the battery by means of a mechanical, electrical, optical or magnetic detection procedure.

### BRIEF DESCRIPTION OF THE DRAWINGS

The present invention will be understood and appreciated more fully from the following detailed description, taken in conjunction with the drawings in which:

FIGS. 1A-1B illustrate schematically, according to a first preferred embodiment of the present invention, a standard prior art battery, adapted by use of a modified positive tip to differentiate a secondary battery from a primary battery;

FIGS. 2A-2C illustrate schematically a preferred embodiment of the corresponding positive current contact in the battery cavity of an electronic device constructed to make use of the modified feature of the batteries of FIGS. 1A and 1B;

FIGS. 3A-3B illustrate schematically, according to another preferred embodiment of the present invention, a scheme similar to that of FIGS. 1A to 2C, but using a modified negative end of the battery;

FIGS. 4A to 4C illustrate schematically, according to another preferred embodiment of the present invention, a scheme whereby a modified battery cross sectional shape is used to differentiate between rechargeable and primary batteries;

FIGS. 5A-5C and 6A-6E illustrate schematically, according to more preferred embodiments of the present invention, schemes whereby a modified battery length is used to differentiate between rechargeable and primary batteries. FIGS. 5A-5E illustrate how a battery of slightly increased length is used, while FIGS. 6A-6E illustrate how a battery of standard length is used;

FIGS. 7A-7E illustrate schematically a further preferred embodiment of the present invention, in which the electrical conductivity of the outer surface of the battery is used for distinguishing a modified battery from a standard battery;

FIGS. 8A-8E illustrate schematically a further preferred embodiment of the present invention, in which electrical continuity is used for distinguishing a modified battery from a standard battery;

FIGS. 9A-9E illustrate schematically a further preferred embodiment of the present invention, in which opto-electronic detection is used for distinguishing a modified rechargeable battery from a standard battery;

FIGS. 10A-10E illustrate schematically a further preferred embodiment of the present invention, in which a transmissive opto-electronic detection method is used for distinguishing a modified rechargeable battery from a standard battery; and

FIGS. 11A-11C illustrate schematically a further preferred embodiment of the present invention, in which magnetic detection is used to determine the presence of a modified battery.

### DETAILED DESCRIPTION OF PREFERRED EMBODIMENTS

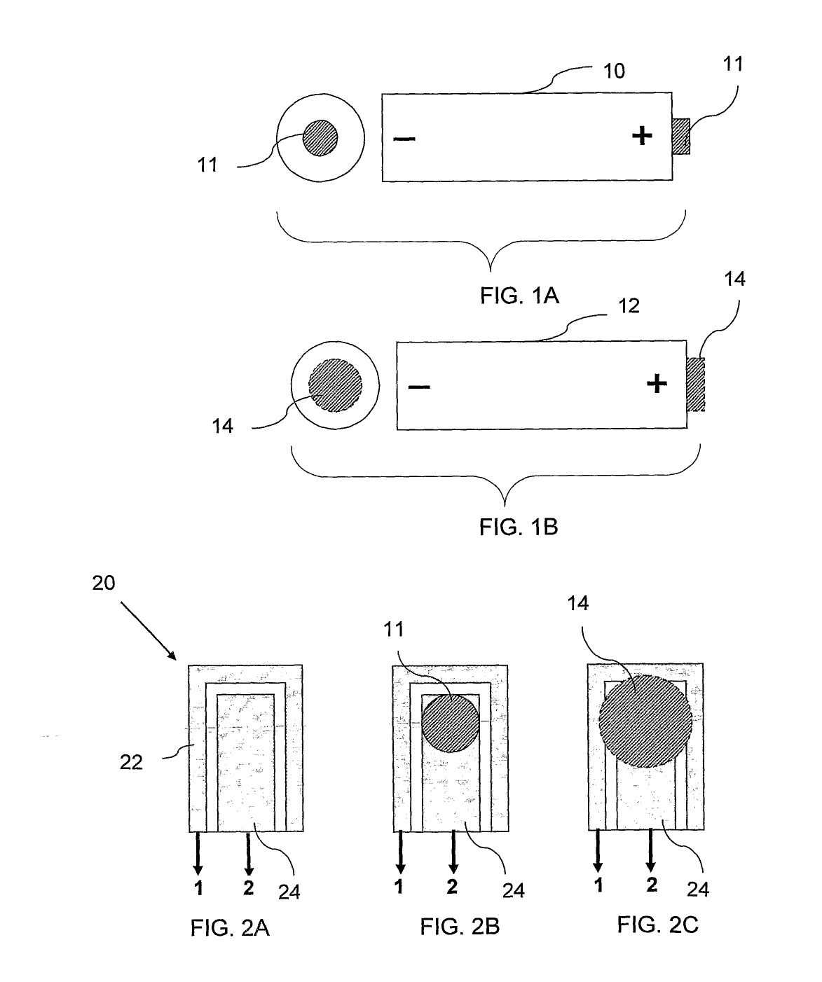

Reference is now made to FIGS. 1A and 1B which illustrate schematically, according to a first preferred embodiment of the present invention, a standard prior art battery, adapted by use of a modified positive tip to differentiate a secondary battery from a primary battery. FIG. 1A shows a completely standard battery 10, with its positive contact 11. According to this preferred embodiment, as shown in FIG. 1B, the rechargeable battery 12 is manufactured to be of the same overall dimensions as the conventional battery of the same size, such that it will fit correctly in the cavity of the device, but having a modified positive contact 14 of larger diameter than that of the standard battery of FIG. 1A. This, and the other preferred embodiments shown in this application, use an AA or an AAA battery as examples for the implementation of the invention. It is to be understood though that the invention is not intended to be limited to such batteries, but is applicable to any standard size and shape of battery in common use.

Reference is now made to FIGS. 2A-2C, which illustrate schematically a preferred embodiment of the corresponding positive current contact 20 in the battery cavity of an electronic device constructed to make use of the modified feature of the batteries of FIGS. 1A and 1B. The modified positive cavity contact has two-parts—an outer contact 22 and an inner contact 24, connected to the device's power circuitry through leads 1 and 2 respectively. As shown in FIG. 2B, the standard sized positive tip 11 of a conventional cell 10 can make contact only with the inner cavity contact 24, connected by lead 2 to the device's power circuitry. On the other hand, when a rechargeable battery 12, modified with a larger diameter positive contact tip 14 is inserted into the cavity, the larger positive tip can make contact with the outer contact 22 of the cavity. Thus, contact 22 and its associated lead 1 can only make contact with the larger diameter positive tip of a rechargeable battery, but not with the positive tip of a standard, non-rechargeable battery. The recharging circuits of the electronic device can be arranged such that they only feed the outer part 22 of the modified positive contact through lead 1, such that only a rechargeable battery of the present invention can be charged when inserted into the device.

Alternatively and preferably, the outer part 22 of the contact can be used simply to detect when a voltage is present, this indicating the presence of a rechargeable battery with a large positive tip 14. The presence of this voltage on lead 1 is then used to enable the device's charging circuit, which can then charge the battery.

Power for regular operation of the device is supplied from the battery through lead 2, attached to the inner part 24 of the modified positive contact, such that either a non-rechargeable or a rechargeable modified battery, when inserted into the battery cavity of the device, will power the device correctly through this inner contact.

Although this preferred embodiment has been shown with the positive tip of the modified battery enlarged in comparison with that of the conventionally sized tip, it is to be understood that the invention could also be adapted to operate if the positive tip of the modified secondary battery were reduced in diameter compared to the standard diameter tip of a regular battery. In this case, however, the invention would operate only by means of a voltage enablement scheme, such as the provision of charging current to the inner contact, only if there is no voltage present on the outer contact. This combination would indicate that there is a modified rechargeable battery with a small diameter tip in the cavity, while a standard sized tip would provide voltage to both parts of the cavity contact, and would thus disable charging.

These embodiments thus fulfill the dual requirements of differentiating between chargeable and primary cells, and of providing transparent operation of the device regardless of which type of battery is used in the cavity.

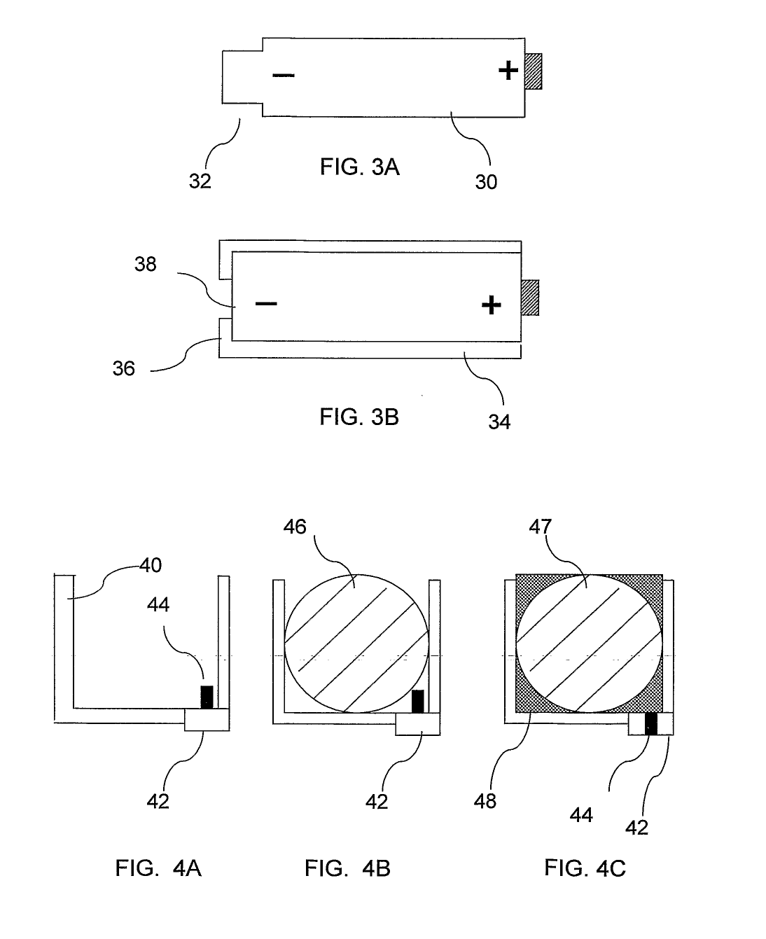

Reference is now made to FIGS. 3A and 3B which illustrate schematically, according to another preferred embodiment of the present invention, a scheme similar to that of FIGS. 1A to 2C, but using a modified negative end of the battery instead. According to this embodiment, as shown in FIG. 3A, the negative end 32 of the rechargeable battery 30 can be modified by decreasing the diameter of the electrical contact area on the end of the battery, such that it has a shape approaching that of the positive tip. The electronic device can then be provided with a modified two-part contact structure, similar to that shown in FIGS. 2A-2C above, preferably with a mechanism such as spring loading to ensure that the battery can be inserted and that the contacts sit firmly against the negative end plate. The operation of the negative contact embodiment of FIGS. 3A and 3B is unlike the positive tip contact embodiment of FIGS. 1A to 2C, in that the outer part of the contact would be used only for detection of the absence or presence of a negative voltage relative to the positive terminal. It is only the inner contact part which makes the current contact with the negative end of the battery. The presence of a voltage (negative) on the outer contact is indicative of a standard battery, which, since it may be a primary battery, is operative to disable the circuits for providing charging current to the inner part of the contact. On the other hand, the absence of a voltage on the outer contact indicates that a modified rechargeable battery 30 with a reduced diameter negative contact end 32 is fitted in the cavity, thus enabling charging of the battery. This embodiment thus mandates the use of sensing circuits to enable the charging function. Alternatively and preferably, as described in the embodiments hereinbelow, a mechanical or opto-electronic method can be used to detect the presence of the reduced diameter at the negative end of the cell, and a charge enabling signal generated therefrom.

Reference is now made to FIG. 3B, which illustrates schematically, an alternative preferred method by which the modified negative end of a rechargeable battery 34 can be implemented, according to a further preferred embodiment of the present invention. In this modified battery 34, the insulating covering applied to the cylindrical surface of the battery is extended such that it also insulates the outer diametrical annulus 36 of the negative end of the battery. The battery is then different from a regular sized battery only by the extent of the insulating cover applied to the battery. It is important that the extent of the added end insulation is not so much that it interferes with the contact between the central part of the end plate 38 and the standard spiral spring used in many current devices, If the end insulation covers an annulus of too large a width, no contact will be made, and the modified rechargeable battery of the present invention will not be useable in such devices. The modified rechargeable battery may not readily operate in current devices which use a spring metallic contact tongue, and full benefit may require slight adaptation of the negative contacts of devices which are to make use of this embodiment.

The advantage of the above described options using modified battery contacts, whether positive tip or negative end, is the backward compatibility generally provided, i.e. that the modified rechargeable batteries can still generally be used in most existing products, and that standard batteries can be used in new devices having modified contacts, but with the added value of enabling the simple and low cost detection of rechargeable batteries in the new devices.

Reference is now made to FIGS. 4A to 4C, which illustrate schematically, according to another preferred embodiment of the present invention, a scheme whereby a modified battery cross sectional shape is used to differentiate between rechargeable and primary batteries. According to these preferred embodiments, the modified rechargeable battery is provided with a distinctively shaped barrel, different from the cylindrical barrel of a standard, prior art battery. A rectangular shaped barrel is a particularly preferred shape.

FIG. 4A shows schematically, one manner in which the battery cavity 40 of the device can be modified, preferably by the addition of a microswitch 42, whose tongue 44 is activated by the shape of the modified rechargeable battery to enable the recharging current to be applied to the battery. FIG. 4B shows a standard cylindrical barrel battery 46 inserted into the cavity, where because of its cross sectional shape, it will not activate the microswitch 42, such that no charging is enabled to the battery.

FIG. 4C shows schematically the insertion into the cavity of a modified rechargeable battery 47 according to this preferred embodiment, the battery having a rectangular cross section 48, which depresses the microswitch tongue 44, activating the microswitch and enabling charging current to be applied to the battery.

Although a mechanically operated microswitch is a particularly simple implementation of the modified cross sectional shape embodiment of this invention, it is to be understood that such a modified shape could also be detected using an optical detection scheme, or an electrical contact scheme, or a magnetic proximity scheme, as is known in the art, without detracting from the novelty of this embodiment.

An advantage of this shape option is that any existing standard-shaped rechargeable battery can be readily converted to the new format of this embodiment by use of a prismatic cover added to the standard battery.

As an alternative to the provision of a completely distinctive shape, the modified rechargeable battery can be provided with a projection at a predetermined position, preferably along the length of the battery, and this projection is detected by the microswitch or other detection mechanism in the battery cavity.

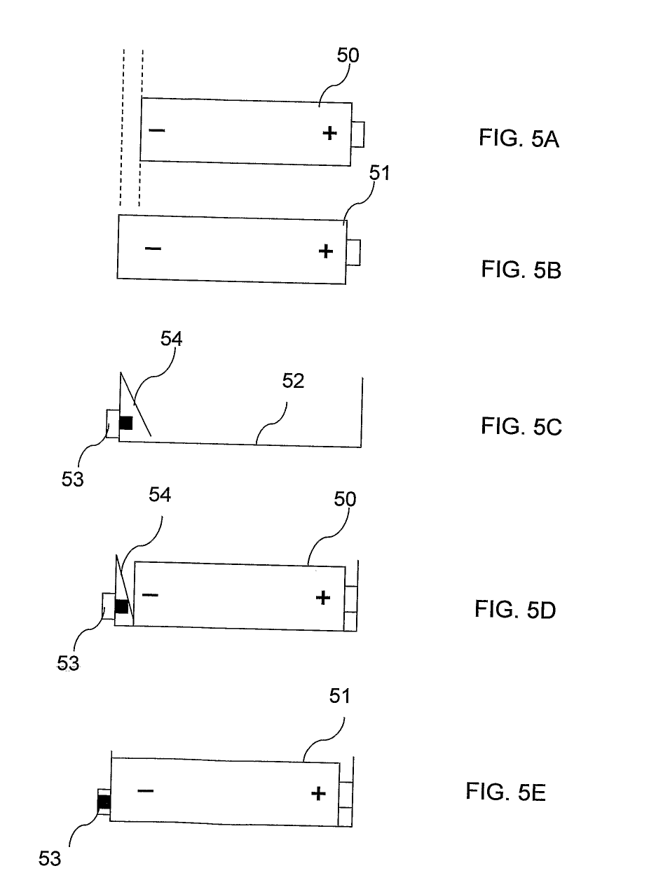

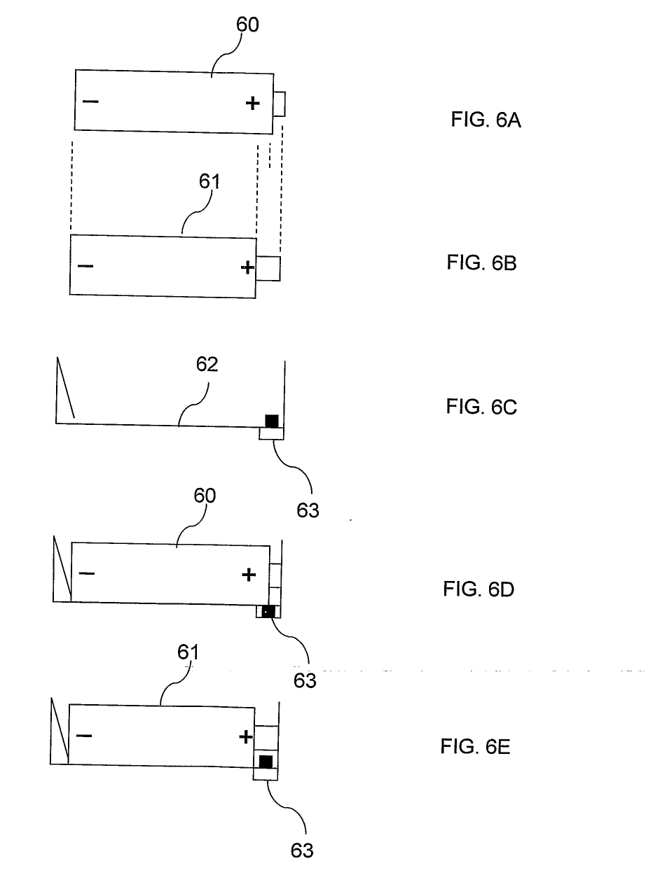

Reference is now made to FIGS. 5A to 5C and 6A to 6E, which illustrate schematically, according to more preferred embodiments of the present invention, schemes whereby a modified battery length is used to differentiate between rechargeable and primary batteries. FIGS. 5A to 5E illustrate an embodiment in which a battery of slightly increased length is used, while FIGS. 6A to 6E illustrate an embodiment in which a battery of standard length is used. According to either of these preferred embodiments, a micro-switch or an opto-electronic switch or any other suitable detection device as suggested hereinabove, is provided in the device battery cavity to detect this amended length, whether it is an increased length or a decreased length.

In the preferred embodiments of FIGS. 5A-5E, since the modified rechargeable battery is lengthened over that of a standard battery, a special battery cavity is required in the electronic device. FIG. 5A schematically shows a standard sized battery 50, as compared to the modified battery 51 of FIG. 5B, which is slightly longer. FIG. 5C shows a schematic drawing of a modified battery cavity 52, to detect the longer modified battery of FIG. 5B. The cavity preferably has a microswitch 53 or equivalently functioning position measuring device, and an appropriately positioned negative contact 54, preferably constructed of a springy tongue as is commonly used in regular battery cavities. FIG. 5D now shows the standard length, unmodified, primary battery of FIG. 5A inserted into the cavity. The battery makes good contact with the negative contact 54 of the cavity, but is not long enough to depress the microswitch 53, or otherwise to activate the length sensor used instead of the microswitch. FIG. 5E now shows the modified length rechargeable battery 51 of FIG. 5B inserted into the cavity. As in FIG. 5D, the battery makes good contact with the negative contact 54 of the cavity, and depresses it sufficiently to activate the microswitch 53 or other length sensor, and thus to enable application of charging current to the cavity.

In order that this changed length embodiment be backward compatible with standard battery sizes, the length change is preferably made by reduction of the length of the body of the battery barrel, but without changing the overall length of the battery from negative end to positive tip, such as is illustrated in FIGS. 6A-6E. FIG. 6A schematically shows a standard sized battery 60, as compared to the modified battery 61 of FIG. 6B, which has a shorter body but the same overall length, such that it can be used in existing, conventional length battery cavities. FIG. 6C shows a schematic drawing of a modified battery cavity 62, to detect the modified battery of FIG. 6B. The cavity preferably has a microswitch 63 or equivalently functioning position measuring device, positioned such that the conventional form battery 60 of FIG. 6A will actuate the microswitch, or alternative sensor when it is inserted into the cavity, as shown in FIG. 6D. This actuation is operative to disable the charging function to the cavity, thus preventing the primary battery from being charged, On the other hand, when a modified rechargeable battery 61 of the present invention, is inserted into the cavity, as in FIG. 6E, the shortened barrel does not actuate the microswitch 63, and charging is thus not disabled.

The length detection scheme shown in FIGS. 6A to 6E could also be used on the above mentioned embodiment of FIG. 3A, showing the reduced diameter negative contact end of the modified battery, since such a reduced diameter negative contact region can also be distinguished by the reduced barrel length at the outer diameter of the negative end of the battery.

It is to be understood that although the non-standard length embodiments have been shown with the apparent increase in length at the negative end of the battery, this is purely for ease of explanation of the operation of the embodiment, and it is equally operative with the increased length “as if” at the positive end.

The previous embodiments of the present invention have been related to physical changes in the dimensions of the modified rechargeable cell. However, it is also possible, according to further preferred embodiments of the present invention, to differentiate between different batteries by means of physical properties of the batteries other than dimensions, such as electrical properties, optical properties or magnetic properties.

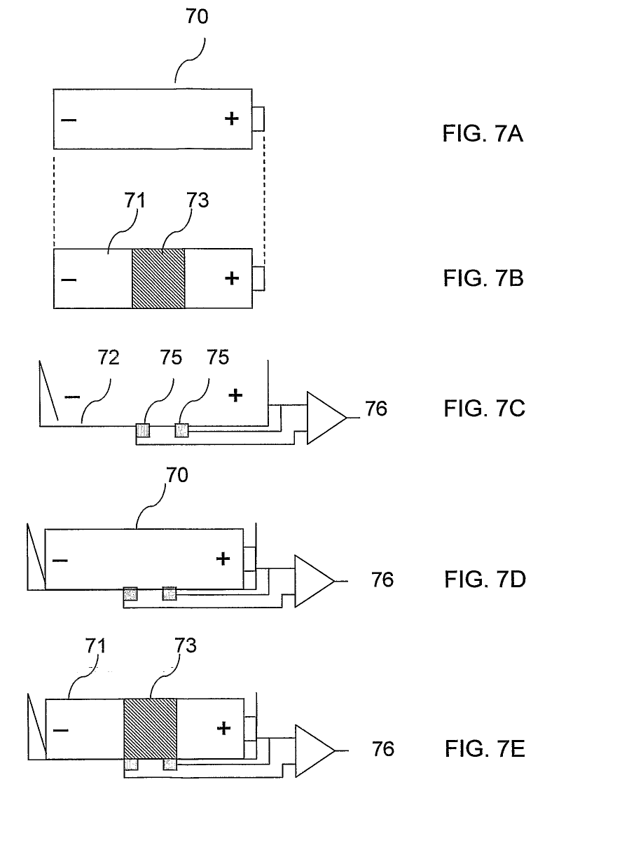

Reference is now made to FIGS. 7A to 7E, which illustrate schematically, a further preferred embodiment of the present invention, in which the electrical conductivity of the outer surface of the battery is used for distinguishing a modified battery from a standard battery. FIG. 7A schematically shows a standard sized battery 70, as compared to the modified rechargeable battery 71 of FIG. 7B, which has the same dimensions, such that it can be used in existing, conventional length battery cavities. The battery of FIG. 7B is modified by the existence of an electrically conductive region 73 over part of its surface. In the preferred embodiment shown, the conductive region is shown at the central region of the barrel. The rest of the surface of the barrel is insulating. FIG. 7C shows a schematic drawing of a modified battery cavity 72, to detect the modified battery of FIG. 7B. The cavity preferably has a pair of electrical contacts 75 disposed such that when the battery of FIG. 7B is inserted, as shown in FIG. 7E, there is electrical continuity between the two contacts. This electrical continuity can be used to activate the charging enabling circuitry 76. If a standard battery 70 is inserted into the cavity, as shown in FIG. 7D, the conventional surface insulation prevents charging from being activated. In order to avoid interference with the normal current flow of the battery, the conductive layer 73 is preferably printed onto the battery insulation, and is not simply a region in which the insulation ahs been removed.

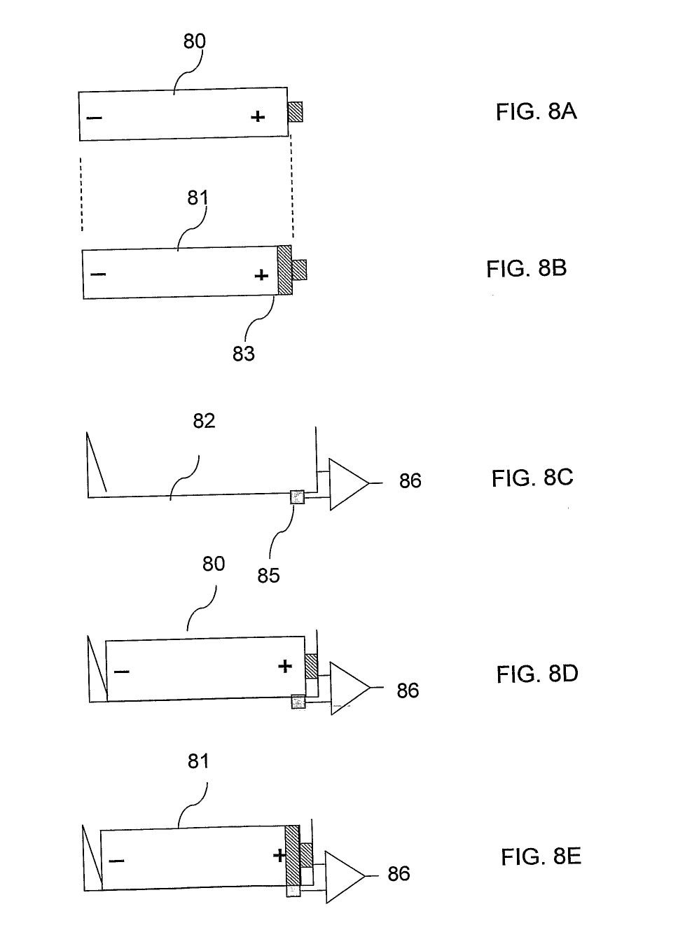

Reference is now made to FIGS. 8A to 8E, which illustrate schematically, a further preferred embodiment of the present invention, in which electrical continuity is used for distinguishing a modified battery from a standard battery. FIG. 8A schematically shows a standard sized battery 80, as compared to the modified rechargeable battery 81 of FIG. 8B, which has the same dimensions, such that it can be used in existing, conventional length battery cavities. The battery of FIG. 8B is modified by the extension of the positive contact region of the battery by means of an electrically conductive layer preferably over part or over the entire top end of the battery 83. FIG. 8C shows a schematic drawing of a modified battery cavity 82, to detect the modified battery of FIG. 8B. The cavity preferably has an electrical contact 85 disposed such that when the modified secondary battery 81 of FIG. 8B is inserted, as shown in FIG. 8E, the contact acquires the same positive voltage as that of the positive battery contact of the cavity. This lack of differential voltage can be used, after inversion, to activate the charging enabling circuitry 86. On the other hand, if a standard battery 80 is inserted into the cavity, as shown in FIG. 8D, there is a voltage difference between the positive lead of the cavity and the contact 85, and this voltage difference can be used to hold-off the charging circuits, such that the conventional battery 80 will not be charged.

In those various embodiments of the rechargeable battery of the present invention which utilize amended mechanical shapes, opto-electronic detection can alternatively be used to detect the presence or absence of the amended mechanical shape of the battery, instead of the above-described mechanical microswitch detection. This can be operative either by detecting the blocking or passage of light passing between an opto-transmitter and detector, due to the presence or absence of the mechanical amendment to the battery shape, or by detecting whether light is reflected or not from the presence or absence of the mechanical amendment. Such an opto-electronic detection scheme can be applied whether to an amended barrel shape, to a mechanical projection, to an increased or decreased length, or even to a modified positive or negative battery tip.

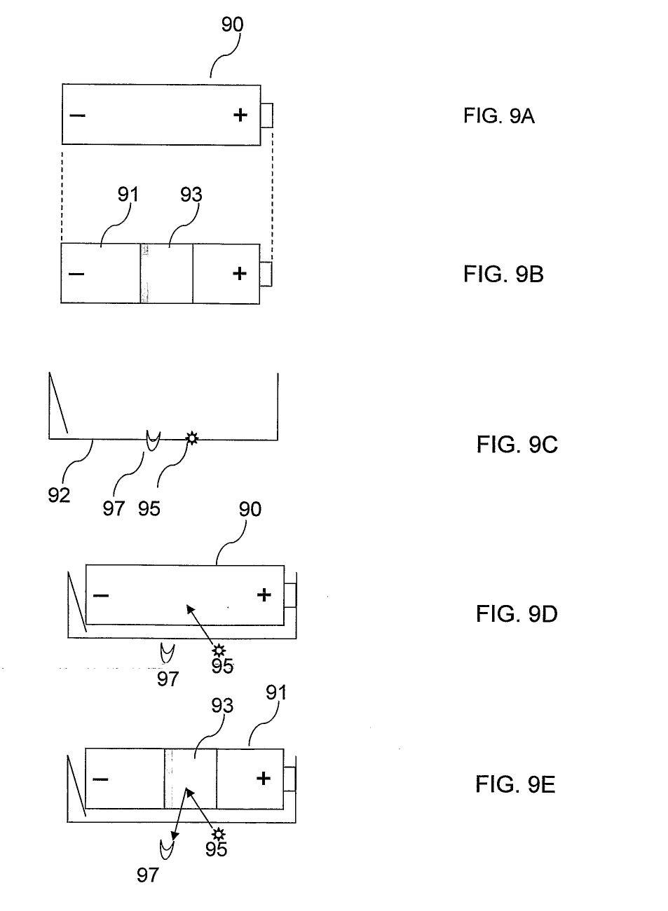

Reference is now made to FIGS. 9A to 9E, which illustrate schematically, a further preferred embodiment of the present invention, in which opto-electronic detection is used for distinguishing a modified rechargeable battery from a standard battery. FIG. 9A schematically shows a standard sized battery 90, as compared to the modified rechargeable battery 91 of FIG. 9B, which has the same dimensions, such that it can be used in existing, conventional length battery cavities. The battery of FIG. 9B is modified by the existence of an optically high reflectivity region 93 over part of its surface. In the preferred embodiment shown, the reflective region 93 is shown at the central region of the barrel. The rest of the surface of the barrel is generally optically absorptive. FIG. 9C shows a schematic drawing of a modified battery cavity 92, to detect the modified battery 91 of FIG. 9B. The cavity preferably has an optical emitter 95, such as a small LED, directed such that it emits a beam in the direction of a battery inserted in the cavity. A photodetector 97 is disposed such that when the modified secondary battery 91 of FIG. 9B is inserted into the cavity, as shown in FIG. 9E, the light emitted from the source 95 is reflected by the reflective region of the modified battery 91, into the photodetector 97. The signal from the photodetector 97 can be used to enable the charging circuits of the electronic device. On the other hand, if a standard battery 90 is inserted into the cavity, as shown in FIG. 9D, the light from the source 95 is diffusely scattered by the battery surface, and no signal is generated by the photodetector 97, such that charging is not enabled.

The embodiment of FIGS. 9A to 9E describes a reflective optical method of differentiating between batteries. However, light can also be used in a transmissive mode to perform this discrimination.

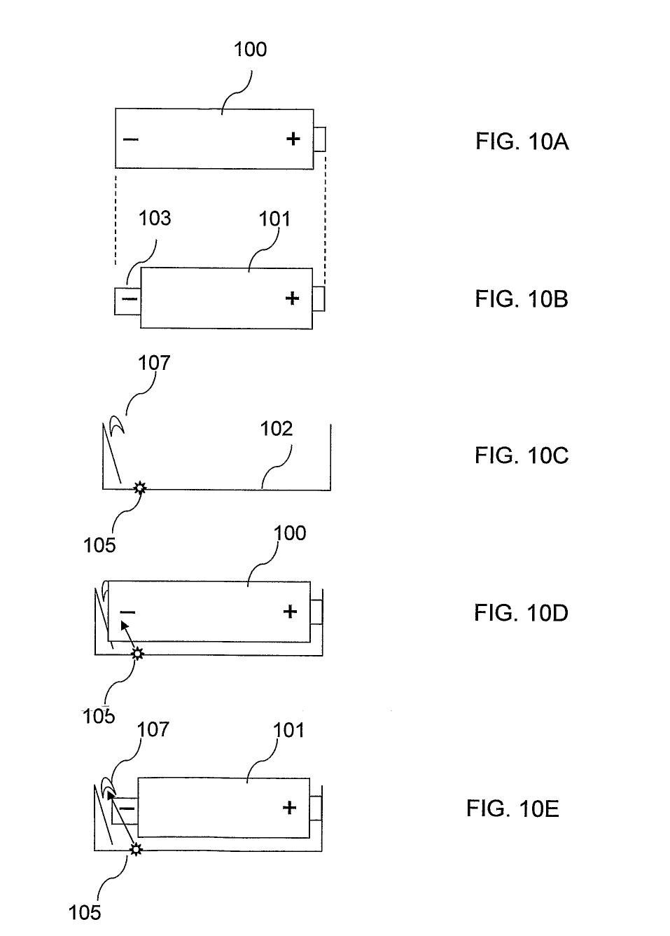

Reference is now made to FIGS. 10A to 10E, which illustrate schematically, a further preferred embodiment of the present invention, in which a transmissive opto-electronic detection method is used for distinguishing a modified rechargeable battery from a standard battery. FIG. 10A schematically shows a standard sized battery 100, as compared to the modified rechargeable battery 101 of FIG. 10B, which has the same dimensions, such that it can be used in existing, conventional length battery cavities. The battery of FIG. 10B is modified by the existence of a reduced diameter barrel 103 at the negative end of the battery, similar to that shown in the embodiment of FIG. 3A. FIG. 10C shows a schematic drawing of a modified battery cavity 102, to detect the modified battery 101 of FIG. 10B. The cavity preferably has an optical emitter 105, such as a small LED, directed such that it emits a beam in the direction of a battery inserted in the cavity. A photodetector 107 is disposed such that, unless blocked, it receives the light emitted by the LED 105. As shown in FIG. 10D, if a standard battery 100 is inserted into the cavity, the light from the source 105 is blocked by the end of the battery, and no signal is generated by the photodetector 97, such that charging is not enabled. On the other hand, when the modified secondary battery 101 of FIG. 10B is inserted into the cavity, as shown in FIG. 10E, the light emitted from the source 105 is not blocked by the battery because of the modified shape of the negative end, and the signal from the photodetector 107 can be used to enable the charging circuits of the electronic device. Instead of a modified barrel end, any other mechanical feature which allows transmission of the light could also be used, such as a groove in the surface, or the like.

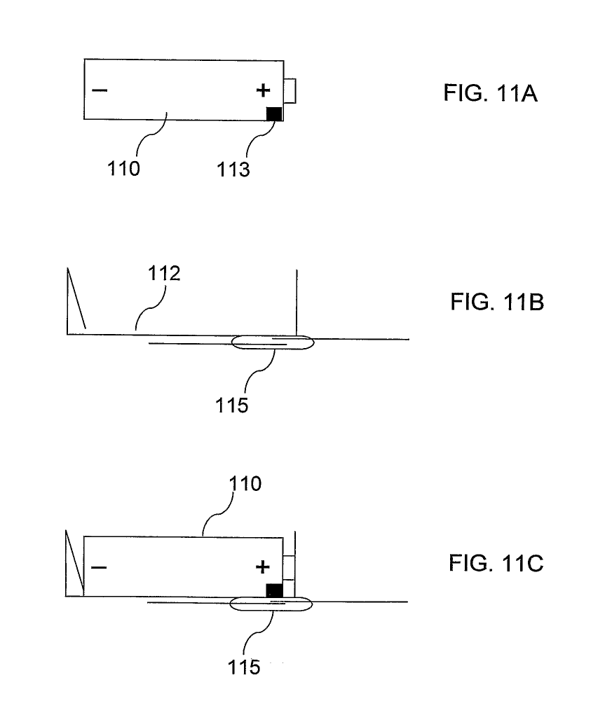

Reference is now made to FIGS. 11A to 11C, which illustrate schematically a further preferred embodiment of the present invention, in which magnetic detection is used to determine the presence of a modified battery. FIG. 11A shows schematically a modified rechargeable battery 110 according to this preferred embodiment, with a small particle of magnetized material 113 mounted on or in the modified battery. The battery cavity 112 shown in FIG. 11C has a magnetic detection unit 115 installed, the output from which is used to enable or disable the charging functionality of the cavity. The magnetic field detector could preferably be a reed switch or a Hall probe or another suitable element sensitive to the presence of a magnetic field. In the embodiment shown in FIG. 11B, a reed switch is depicted, whose contacts close in the vicinity of a magnetic field. FIG. 11C shows the insertion of the modified battery 110 into the cavity 112, thus actuating the magnetic switch 115 by closing its contacts, which can be connected to the charging control to enable the charging circuits in the electronic device to operate. A conventional battery without the magnet would not affect the reed switch, and so could not be charged. Since the magnetic field passes through the casing of the battery, this embodiment of the present invention can also be implemented with the magnetized material mounted within the body of the battery, rather than being an external physical appurtenance, as with the previously described embodiments of this application. This can be achieved during manufacture by mounting a tiny magnet within the battery in a predetermined location, and arranging that the position of the magnetic field detector in the battery cavity is such that it is sensitive to the presence of the magnetic field from the battery.

All of the above referenced embodiments have been described in terms of the rechargeable battery being modified, and the standard form being used for the primary battery. This would appear to be the more logical choice since primary batteries are the more basic and have more widespread use. However, it is to be understood that the present invention is not meant to be limited to this arrangement, but is equally applicable to embodiments wherein the rechargeable battery is the standard battery, and the primary battery is the modified battery.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A system for providing battery power to an electronic device having a battery cavity, said system comprising:
a battery having at least one physical characteristic other than its chemistry for differentiation between rechargeable and non-rechargeable types; and
a corresponding feature of said battery cavity adapted to differentiate between said battery types by means of said physical characteristic.

2. A system according to claim 1 and wherein said physical characteristic is the external shape of said battery.

3. A system according to claim 2 and wherein said external shape is an essentially rectangular barrel, and said corresponding feature of said battery cavity is either of a micro-switch and an opto-electric circuit activated by said essentially rectangular barrel.

4. A system according to claim 2 and wherein said battery has a generally cylindrical body, and said external shape is a projection from said generally cylindrical barrel, and said corresponding feature of said battery cavity is any one of a micro-switch and an opto-electrical circuit activated by said projection.

5. A system according to claim 1, and wherein said electronic device comprises charging circuits which are applied to said battery only when said corresponding feature discerns that said physical characteristics are those associated with a rechargeable battery.

6. A system according to claim 1 and wherein said physical characteristic is the size of the positive contact of said battery.

7. A system according to claim 6 and wherein said corresponding feature of said battery cavity is a two-part contact adapted to provide an enabling signal to provide recharging current only to a battery having a positive contact of at least a predetermined diameter.

8. A system according to claim 6 and wherein said corresponding feature of said battery cavity is a two-part contact adapted to provide an enabling signal to provide recharging current only to a battery having a positive contact of less than a predetermined diameter.

9. A system according to claim 1 and wherein said physical characteristic is either one of the size and shape of the negative contact of said battery.

10. A system according to claim 9 and wherein said corresponding feature of said battery cavity is a two-part contact adapted to provide an enabling signal to provide recharging current only to a battery having a negative contact of less than a predetermined diameter.

11. A system according to claim 1 and wherein said physical characteristic is a partial coverage of the negative base of said battery by an insulating layer.

12. A system according to claim 11 and wherein said corresponding feature of said battery cavity is a negative contact adapted to provide an enabling signal to provide recharging current only to a battery having said partial coverage of the negative base of said battery by an insulating layer.

13. A system according to claim 1 and wherein said physical characteristic is the length of said battery.

14. A system according to claim 13 and wherein said length is different from that of a standard battery, and said corresponding feature in said electronic device is either of a micro-switch and an opto-electric circuit activated by a battery of said different length.

15. A system according to claim 1 and wherein said physical characteristic is the presence of a magnetized material mounted in or on said battery.

16. A system according to claim 15 and wherein said corresponding feature of said battery cavity is a magnetic field detection element adapted to provide an enabling signal to provide recharging current only to a battery having said magnetized material associated with it.

17. A system according to claim 1 and wherein said physical characteristic is a region of electrical conductivity on the generally insulating outer surface of said battery.

18. A system according to claim 17 and wherein said corresponding feature of said battery cavity is a pair of electrical contacts which are connected and thus provide an enabling signal to provide recharging current only by a battery having said region of electrical conductivity on its generally insulating outer surface.

19. A system according to claim 3 and wherein said opto-electric circuit comprises an emitter and a photodetector, and said circuit is closed when a battery having a predetermined reflective part of its surface is inserted into said cavity, such that light from said emitter is reflected into said photodetector.

20. A system according to claim 3 and wherein said opto-electric circuit comprises an emitter and a photodetector, and said circuit is closed when a battery having a predetermined modified shape is inserted into said cavity, such that light from said emitter is transmitted into said photodetector.

21-23. (canceled)
